(19) United States
(12) Patent Application Publication
(10) Pub. No.: US 2011/0258236 A1
(43) Pub. Date: Oct. 20, 2011

(54) Secure Hotspot Roaming

(76) Inventor: Pradeep J. Iyer, Cupertino, CA (US)

(21) Appl. No.: 13/088,293

(22) Filed: Apr. 15, 2011

Related U.S. Application Data
(60) Provisional application No. 61/324,959, filed on Apr. 16, 2010.

(51) Int. Cl. G06F 17/30

(52) U.S. Cl. 707/802; 707/E17.005

(57) ABSTRACT

Secure hotspot roaming in wireless networks. An enterprise works with one or more hotspot providers to provide secure access to its clients through hotspot locations. The enterprise provides the hotspot provider, or service provider (SP), with the addresses of enterprise controllers used for client authentication. The SP maintains a database for its controllers which maps the enterprise realm to the address of the enterprise controller. When a client connects to a hotspot access point (AP), the hotspot AP sends client information such as MAC address to a SP controller. The SP controller determines if this is a new or a known client by looking up the client information in a local client to realm database. If the client is known and the realm associated with the client has an entry in the realm to enterprise controller database, the hotspot AP is instructed to begin client authentication with the specified enterprise controller. If the client is not known, authentication begins with the SP controller, and the client is queried for realm information. An entry is made in the SP controller's client to realm database for the client. If a corresponding record is present in the realm to enterprise database, the SP controller instructs the hotspot AP to dynamically switch authentication from the SP controller to the enterprise controller. The realm to enterprise database may also be placed on the hotspot AP, so that the hotspot AP may determine if the client should be passed to an enterprise controller and begin authentication with the enterprise controller directly.

### CROSS-REFERENCE TO RELATED APPLICATIONS

This application claims the benefit of priority on U.S. Provisional Application No. 61/324,959 filed on Apr. 16, 2010.

### BACKGROUND OF THE INVENTION

The present invention relates to wireless digital networks, and in particular, to the problem of supporting secure roaming.

Wireless digital networks are becoming ubiquitous in enterprises, providing secure and cost-effective access to resources. Those networks usually have one or more controllers, each controller supporting a plurality of access points (AP) deployed through the enterprise. Wi-Fi networks operating in accordance with IEEE 802.11 standards are examples of such networks.

While enterprise clients are within the range of enterprise APs, they have secure access to resources such as intranets, and protected access to the Internet. Outside the enterprise, however, secure access to enterprise resources is more difficult. Users may rely on solutions such as virtual private networks (VPNs) or other software tools to establish a secure communications link back to the enterprise network.

As wireless networks have become more ubiquitous, and the availability of wireless access such as 802.11 wireless access has moved from a novelty to an expectation, many businesses have sought to use the availability of Wi-Fi access at their locations as a way of drawing and keeping customers. A diverse set of businesses now offer Wi-Fi access to patrons, including hotels, coffee shops, fast food emporia, bookstores, and transit services.

While many of these business realize that Wi-Fi services may be a valuable way to build and keep clientele, they may not wish to go into the wireless business, and instead contract out these services to a service provider. The service provider works with the business, often a chain, to install and operate wireless access points, often called hotspots.

Customers, end users of such hotspots know that they will have simple, easy wireless access when they visit a particular provider.

What is needed is a way of providing secure enterprise access through hotspots.

### BRIEF DESCRIPTION OF THE DRAWINGS

The invention may be best understood by referring to the following description and accompanying drawings that are used to illustrate embodiments of the invention in which:

FIG. 1 shows clients in a wireless network.

### DETAILED DESCRIPTION

Embodiments of the invention relate to methods of providing secure hotspot access to an enterprise network via hotspots. A typical hotspot consists of one or more wireless access points (APs) in a location, typically operated by a service provider (SP). In normal operation, a wireless client associates with a hotspot AP. The hotspot AP connects to a SP controller typically at a network operations center (SP NOC) to authenticate the client, sending identifying client information typically including the client MAC address. If the client is identified by the SP as a returning user, they are authenticated and then provided with Internet access through the SP. If the client is new, the authentication process continues, possibly requesting subscription and/or payment information from the client. When authenticated, the client is given Internet access through the SP.

According to the present invention, an enterprise works with the SP to provide secure access to enterprise clients. The SP maintains a realm database in SP controllers which maps client enterprises to addresses of the enterprise controllers on the customer's premises (CPEs). This address may be for example a FQDN or a TCI/IP address.

When a client device connects to a hotspot AP, the AP connects to a SP controller, sending information including client information, which may include the client MAC address. The SP controller looks up the client, such as by MAC address, in its client to realm database.

If the client is known, and no realm information is associated with the client, authentication proceeds with the SP controller, and on successful authentication, the client is provided Internet access through the SP controller.

If the client is known, and a realm is associated with the client, that realm is looked up in the SP controller's realm to enterprise database. If an entry is present, signifying that this client is to be transferred to an enterprise CPE controller, the hotspot AP is instructed to start client authentication with the CPE controller contained in the realm database. The hotspot AP then establishes a connection between the client and the specified CPE controller and client authentication continues with the CPE controller.

If the client is not known, client authentication continues with the SP controller to obtain realm information from the client. The realm information is looked up in the realm to enterprise database. If the address of an enterprise controller is present for the realm, the authentication process which is underway must be dynamically moved from the SP controller to the specified enterprise controller.

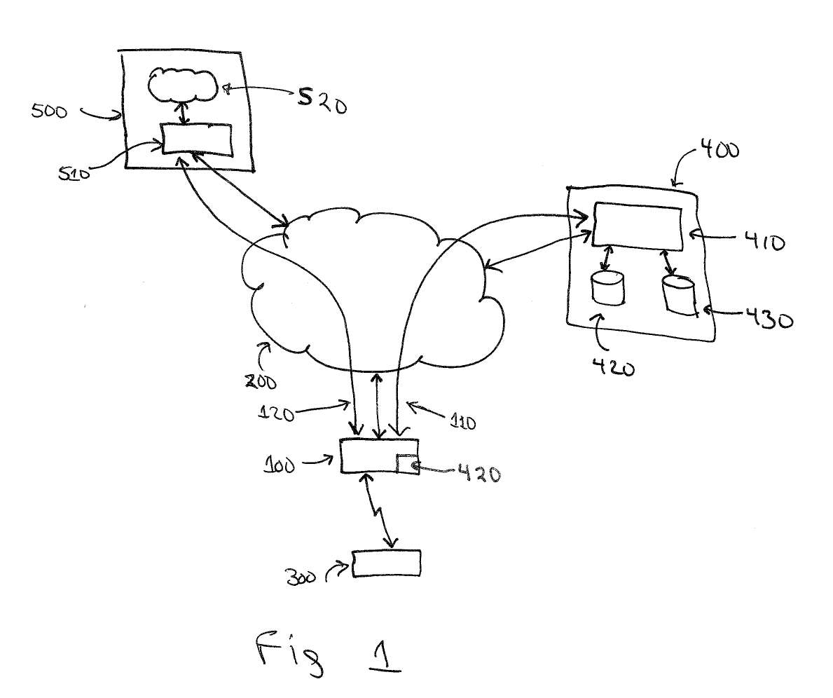

FIG. 1 shows a network in which access point (AP) 100 connects to the Internet 200 or other packet-switched network. AP 100 also supports wireless connections to clients 300. In operation according to the invention, AP 100 communicates with service provider 400 and with service provider (SP) controller 400. AP 100 also communicates with enterprise 500 controller 510.

As is known to the art, controllers 410, 510 and hotspot APs 100 are purpose-made digital devices, each containing a processor, memory hierarchy, and input-output interfaces. In one embodiment of the invention, a MIPS-class processor such as those from Cavium or RMI is used. Other suitable processors, such as those from Intel or AMD may also be used. The memory hierarchy traditionally comprises fast read/write memory for holding processor data and instructions while operating, and nonvolatile memory such as EEPROM and/or Flash for storing files and system startup information. Wired interfaces are typically IEEE 802.3 Ethernet interfaces, used for wired connections to other network devices such as switches, or to a controller. Wireless interfaces may be WiMAX, 3G, 4G, and/or IEEE 802.11 wireless interfaces. In one embodiment of the invention, controllers and hotspot APs operate under control of a LINUX operating system, with purpose-built programs providing host controller and access point functionality.

According to the present invention, a service provider (SP) 400 operates one or more wireless hotspots. Each hotspot has a hotspot access point (AP) 100. This hotspot AP may communicate with a local controller at the location, or it may be connected directly to the Internet 200. An internet connection may be provided, for example, by a cable modem, DSL modem, optical fiber, or a wireless connection such as Wi-Fi, WiMAX, 3G, 4G, or other wireless connection. The hotspot AP communicates with a service provider controller 410, such as one of a plurality of SP controllers.

While these controllers 410 may be located at a service provider network operations center (SP NOC) as shown in FIG. 1, a SP controller or SP controller functionality may also be located in the hotspot.

It should be noted that the SP may be a separate organization from the operator of the hotspot location. As an example, a chain of coffee shops may contract with a regional or nationwide telecommunications company to provide Wi-Fi hotspots at its locations. It may also be the case that for large organizations already having a substantial information technology (IT) component, they may act as a SP for their organization and its outlets wishing to have Wi-Fi hotspots.

An enterprise 500 wishing to provide secure roaming access to its clients works with one or more SPs 400 to provide access. While this may be an informal relationship, typically it will be a more formal relationship such as a contract. The enterprise gives the SP the address of one or more of its controllers 510 for client authentication. This information may be in the form of TCP addresses, or fully qualified domain names (FQDN) for the enterprise controllers 510 which handle client authentication. The SP populates this information in the realm to Enterprise Controller database 420 of its controllers 410. In one embodiment of the invention, such information may be deployed across multiple controllers 410 operated by the SP in multiple locations; in other embodiments, coverage may be coupled to remuneration, such as requiring fees for different regions.

Updates to the realm to enterprise database 420 may be pushed from the SP to its controllers 410, or updates may be pulled down from a service provider central database to the SP controller 410 and its real to enterprise database 420. Centrally located databases, each serving a plurality of controllers 410 could also be used.

Note that no security or cryptographic information such as certificates or passwords have been provided by the enterprise to the SP, or are retained by the SP. All the SP has in its Realm to enterprise database 420 is a mapping of enterprise realms to addresses of enterprise controllers.

In the following example, IEEE 802.11 protocols including 802.1x authentication are used. It is understood by those familiar with the art that other wireless protocols and other authentication protocols may be used.

According to the invention, a wireless client 300 associates with a hotspot AP 100. This association involves an exchange of messages including client identification information such as the unique MAC address of the client device 300.

Hotspot AP 100 communicates 110 with SP controller 410, sending a message (CLIENT_UP) containing client identification, in this example MAC address of client 300.

SP controller 410 checks with its client to Realm mapping database 430 which maps client MAC addresses to realms.

If there is a hit, the user is known. If realm information is not present for the client, processing continues at SP controller 410. This may include additional authentication steps. When properly authenticated, client 300 is typically given Internet access through SP controller 410.

If realm information is present in the client to realm database 430, the realm is looked up in the realm to enterprise database 420. If an entry is present in the realm to enterprise database 420 giving the address of an enterprise controller 510, a message is sent to hotspot AP 100 to begin authentication between client 300 and enterprise controller 510.

Hotspot AP 100 establishes a tunnel 120, preferably a secure tunnel such as an IPSec tunnel, to enterprise controller 510. Client 300 authenticates with enterprise controller 510. Once client 300 has been authenticated by enterprise controller 510, client 300 may have access to intranet resources 520 inside enterprise 500, which may include access to the wider internet 200. Note that in this case, all authentication has been performed by enterprise controller 510, with no sensitive information passing to or through SP controller 410.

If there is a miss in the client to realm database 430, authentication of client 300 begins with the SP controller 410. SP controller 410 learns client 300's user name which has realm information during authentication (inner authentication phase for 802.1x). As an example, the realm may be extracted from the user name: the user “john @ yoyodyne.com” would be associated with the realm “yoyodyne.com”.

SP controller 410 adds the client MAC and realm information to its client to realm mapping database 430.

SP controller 410 looks up the client realm for client 300 in realm to enterprise database 420.

If a match is found, SP controller 410 sends a message to hotspot AP 100 to dynamically transfer authentication of client 300 to enterprise controller 510 specified in the realm to enterprise database 420. Note that to this point of the process, no client-enterprise information other than realm identification and enterprise controller identification information has been stored or transmitted to the SP.

Optionally, if the client realm is not in the realm to enterprise controller database 420, SP controller 410 may pass this inquiry to other SP controllers 410, or to a central SP server.

Once an enterprise controller 510 is identified, hotspot AP 100 begins the process of dynamically transferring authentication from the SP controller 410 to the specified enterprise Controller 510.

For embodiments in which 802.1x authentication is used, the client is known as the supplicant, and hotspot AP 100 tears down the initial authentication session using SP controller 410 as the authenticator and establishing a new authentication session using the specified enterprise Controller 510 as the authenticator. The exact steps involved in dynamically transferring authentication may vary with the type of authentication used.

In one embodiment of the invention, hotspot AP 100 temporarily blacklists client 300, which keeps the client from reconnecting to hotspot AP 100 while the old authentication session with SP controller 410 is being torn down and the new authentication session to enterprise Controller 510 is being set up. Blacklisting client 300 disconnects the client from hotspot AP 100, which automatically triggers the teardown process on the old authentication session with SP controller 410. Client 300 makes repeated attempts to reconnect to hotspot AP 100, but because of the temporary blacklist, is unable to reconnect.

Hotspot AP 100 sets up a tunnel, preferably a secure tunnel 120 such as an IPSec tunnel, with the specified enterprise controller 510.

Hotspot AP 100 removes the client 300 from the temporary blacklist. The next client association request will be accepted by the hotspot AP 100, which forwards client 300 traffic through the tunnel 120 to the designated enterprise controller 510 for authentication.

Authentication of client 300 is handled by enterprise controller 510 with all traffic passing through tunnel 120.

According to the invention, designated enterprise controller 510 is the 802.1x Authenticator, and once the client is authenticated, Wi-Fi encryption terminates on it.

Once client 300 has been authenticated by enterprise controller 510, client 300 may have access to intranet resources 520 inside enterprise 500, which may include access to the wider internet 200.

Note that no authentication traffic between client 300 (802.1x supplicant) and the designated enterprise controller 510 (802.1x authenticator) has been sent through or to the SP controller 410; all traffic has been passed through a tunnel 120 between the hotspot AP 100 and the designated enterprise controller 510.

In an alternate embodiment of the invention, the realm to enterprise database 420 is present on each hotspot AP 100. This realm to enterprise database 420 may be pushed down to hotspot APs 100 by SP 400, or each hotspot AP 100 may retrieve the realm to enterprise database 420 from SP 400.

In this embodiment, when client 300 associates with hotspot AP 100, hotspot AP 100 extracts the realm information from client 300. Hotspot 100 searches its copy of the realm to enterprise database 420 for the realm associated with client 300. If an entry is present, hotspot AP 100 sets up a tunnel 120, preferably a secure tunnel such as an IPSEC tunnel to the designated enterprise controller 510. Authentication then proceeds as in previous embodiments. If no realm to enterprise information is present in database 420 for client 300, then client processing proceeds through SP controller 410.

As is understood in the art, the controller and access points are purpose-built digital devices, each containing a CPU for executing instructions and manipulating data, a memory hierarchy for storing data and instructions, and input/output devices such as wired and wireless communications ports.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. An apparatus comprising:
means for receiving one or more addresses corresponding to one or more controllers associated with an enterprise network system; and
means for populating the one or more addresses to an enterprise database.
